(19) United States
(12) Patent Application Publication
(10) Pub. No.: US 2005/0236955 A1
(43) Pub. Date: Oct. 27, 2005

(54) Flat cathode ray tube

(75) Inventor: Yoon San Park, Kumi-si (KR)

Correspondence Address: BIRCH STEWART KOLASCH & BIRCH, PO BOX 747, FALLS CHURCH, VA, 22040-0747, US

(73) Assignee: LG. Philips Displays Korea CO., LTD., Kumi-Si (KR)

(21) Appl. No.: 11/075,807

(22) Filed: Mar. 10, 2005

(30) Foreign Application Priority Data
Mar. 11, 2004 (KR) 2004-16659

(51) Int. Cl. H01J 29/80; H01J 29/81; H01J 29/07

(52) U.S. Cl. 313/402; 313/407

(57) ABSTRACT

A flat cathode ray tube comprising a panel having a substantially-flat outer surface and an inner surface having a certain curvature, a funnel coupled to a rear end of the panel to form a hollow vacuum body, an electron gun fitted in a neck portion of the funnel to emit electron beams, and a shadow mask arranged at the inner surface of the panel in a state of being spaced apart by a certain distance from the inner surface of the panel, and formed with a plurality of electron beam slots, wherein the shadow mask has a curvature satisfying, at an optional point on the shadow mask, the condition “Rh≧Rv”, where “Rh” represents a shorter-axis radius of the curvature, and “Rv” represents a longer-axis radius of the curvature. Using this structure, it is possible to prevent a degradation in the structural strength of the shadow mask.

### BACKGROUND OF THE INVENTION

1. Field of the Invention

The present invention relates to a flat cathode ray tube, and, more particularly, to a flat cathode ray tube which includes a shadow mask having optimal radii of curvature along longer and shorter axes of the shadow mask to prevent a degradation in the structural strength of the shadow mask caused by a panel of the cathode ray tube, which has an inner surface with an approximately-flat curvature.

2. Description of the Related Art

FIG. 1 is a schematic view illustrating a configuration of a general color flat cathode ray tube. As shown in FIG. 1, the general flat color cathode ray tube includes a panel 1 having a flat outer surface and an inner surface having a certain curvature, and a funnel 2 coupled to a rear end of the panel 2 with frit glass to form a hollow vacuum body.

Phosphors are coated on the inner surface of the panel 1 to form a screen (not shown) functioning to emit light. The flat color cathode ray tube also includes an electron gun 8 mounted to a neck portion of the funnel 1 to emit electron beams, and thus, to enable the screen to emit light, a deflection yoke 9 adapted to generate an electric field to vertically and horizontally deflect the electron beams 6 emitted from the electron gun 8, and a shadow mask 3 adapted to perform a color selecting function for the electron beams 6 deflected by the deflection yoke 9, and thus, to enable the phosphors of the screen to emit selected color components.

The flat color cathode ray tube further includes a frame 4 adapted to support the shadow mask 3, a spring 5 adapted to couple the frame 4 to the panel 1, and an inner shield 7 fixed to the frame 4 to shield against external earth magnetism. A reinforcing band 10 is mounted to a skirt portion of the panel 1, in order to prevent the hollow vacuum body from easily imploding by external impact under the high vacuum state of the hollow vacuum body.

In the flat color cathode ray tube having the above-mentioned configuration, the electron beams 6, which are emitted from the electron gun 8 fitted in the neck portion of the funnel 2, are vertically and horizontally deflected by the deflection yoke 9. The deflected electron beams 6 then reach the screen after passing through slots of the shadow mask 3, so that an image is reproduced.

Meanwhile, the above-mentioned flat cathode ray tube has a problem in that the panel 1 has a flat outer surface and an inner surface having a certain curvature, so that the panel 1 exhibits a low structural strength, and thus, may be easily damaged by external impact, as compared to general panels having inner and outer surfaces each having a certain curvature.

In order to solve such a problem, the above-mentioned flat cathode ray tube has a panel structure in which the peripheral portion of the panel 1 has a thickness larger than that of the central portion of the panel 1. The ratio of the thickness of the central panel portion to the thickness of the peripheral panel portion is expressed by a wedge rate. Generally, the above-mentioned flat cathode ray tube is designed to have a panel wedge rate of 200% or more, in order to secure a desired structural strength of the shadow mask 3.

Thus, the important factor in designing the shadow mask 3 is the inner surface curvature radius of the panel 1. Typically, the shadow mask 3 is designed to have a radius of curvature corresponding to 80 to 90% of the inner surface curvature radius of the panel 1, in order to secure a desired structural strength of the shadow mask 3.

However, when the panel 1 has a wedge rate of 200% or more, another problem may occur in that the peripheral panel portion exhibits a transmissivity greatly lower than the transmissivity of the central panel portion, so that the important quality of the screen, that is, brightness uniformity, may be degraded.

For this reason, a method of adjusting the wedge rate of a panel, based on the transmissivity of the panel determined by the material of the panel, has conventionally been used as the method for solving the above-mentioned problem.

TABLE 1
Transmissivity Ratio of Central
Panel Portion to Peripheral Penal
Portion (%)

| | Clear Panel | Tinted Panel | |
|---|---|---|---|
| Wedge Rate | (Transmissivity | (Transmissivity | |
| (%) | Ratio of 81%) | Ratio of 56%) | Remarks |
| 180 | 91.6 | 67.8 | Thickness of |
| 190 | 90.6 | 64.6 | Central Panel |
| 200 | 89.6 | 61.5 | Portion: |
| 210 | 88.6 | 57.4 | 10.5 mm |
| 220 | 87.6 | 55.8 | |
| 230 | 86.7 | 53.2 | |

TABLE 1 describes light transmissivities of clear and tinted panels depending on the panel wedge rates of the panels. Although clear glass having a light transmissivity of 80% or more is generally used to prevent a degradation in brightness uniformity, there may be a problem in this case in that a degradation in contrast characteristics may occur due to such a high light transmissivity. When a reduction in panel wedge rate is implemented to solve such a problem, the inner surface curvature of the panel is varied, causing a great reduction in the structural strength of the shadow mask. As a result, there may be a problem in that drop or howling characteristics are greatly degraded.

### SUMMARY OF THE INVENTION

The present invention has been made in view of the problems incurred in the above-mentioned conventional case, and it is an object of the invention to provide a flat cathode ray tube which includes a shadow mask having optimal radii of curvature along longer and shorter axes of the shadow mask to prevent a degradation in the structural strength of the shadow mask caused by a panel of the cathode ray tube, which has an inner surface with an approximately-flat curvature.

Another object of the invention is to provide a flat cathode ray tube which includes a panel having a structure designed to simultaneously satisfy desired brightness uniformity and contrast characteristics of the panel, and a shadow mask having a structure designed in accordance with the panel structure, so that the flat cathode ray tube can reproduce a high-quality image with minimal costs.

In accordance with the present invention, these objects are accomplished by providing a flat cathode ray tube comprising a panel having a substantially-flat outer surface and an inner surface having a certain curvature, a funnel coupled to a rear end of the panel to form a hollow vacuum body, an electron gun fitted in a neck portion of the funnel to emit electron beams, and a shadow mask arranged at the inner surface of the panel in a state of being spaced apart by a certain distance from the inner surface of the panel, and formed with a plurality of electron beam slots, wherein the shadow mask has a curvature satisfying, at an optional point on the shadow mask, the following condition:
Rh≧Rv
where, “Rh” represents a shorter-axis radius of the curvature, and “Rv” represents a longer-axis radius of the curvature.

The shorter-axis curvature radius of the shadow mask may range from 1,200 mm to 1,600 mm.

The longer-axis curvature radius of the shadow mask may range from 1,200 mm to 1,500 mm.

The inner surface curvature of the panel may have a radius of not less than 1,600 mm.

The panel may be made of tinted glass, and may have a central portion exhibiting a light transmissivity of 40 to 70%.

### BRIEF DESCRIPTION OF THE DRAWINGS

The above objects, and other features and advantages of the present invention will become more apparent after reading the following detailed description when taken in conjunction with the drawings, in which:

FIG. 1 is a schematic view illustrating a configuration of a general color flat cathode ray tube;

FIG. 2 is a schematic perspective view illustrating a panel and a shadow mask included in a flat cathode ray tube according to the present invention;

FIG. 3 is a schematic sectional view illustrating the panel and shadow mask included in the flat cathode ray tube according to the present invention; and

FIG. 4 illustrates comparison of the stress characteristics of the shadow mask in the flat cathode ray tube according to the present invention with the stress characteristics of a conventional shadow mask.

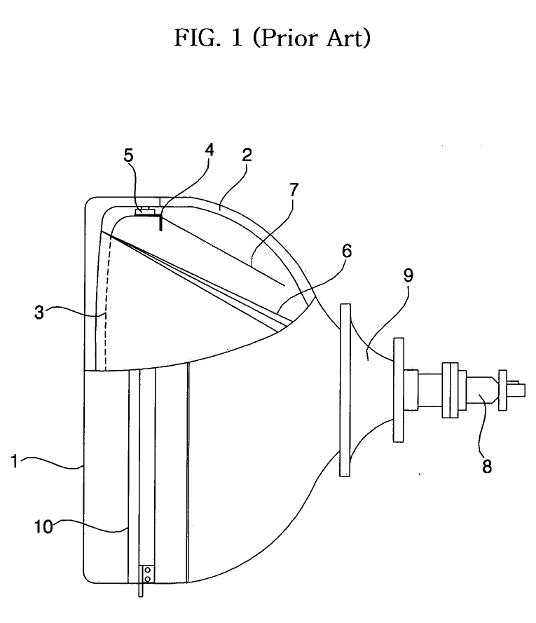

### DESCRIPTION OF THE PREFERRED EMBODIMENTS

Hereinafter, exemplary embodiments of a flat cathode ray tube according to the present invention will be described with reference to the annexed drawings.

Although a number of embodiments may be implemented for the flat cathode ray tube according to the present invention, the following description will be given in conjunction with the most preferable embodiment. Also, since the basic structure of the flat cathode ray tube is similar to that of the above-mentioned conventional case, no detailed description thereof will be given.

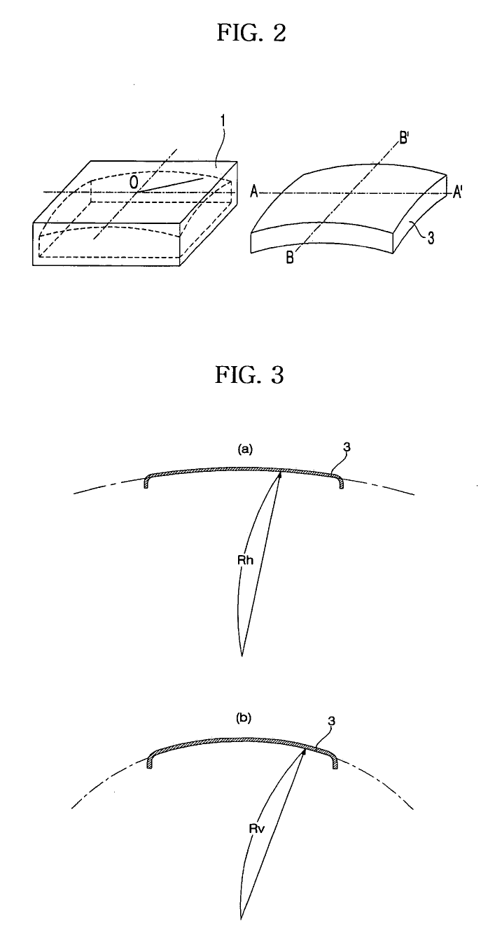

FIG. 2 is a schematic perspective view illustrating a panel and a shadow mask included in the flat cathode ray tube according to the present invention. FIG. 3 is a schematic sectional view illustrating the panel and shadow mask included in the flat cathode ray tube according to the present invention.

First, the design characteristics of the shadow mask, which is arranged on the inner surface of the panel, will be described. As shown in FIG. 2, the shadow mask, which is designated by reference numeral 3, is designed, depending on the inner surface curvature of the panel, which is designated by reference numeral 1. That is, the shadow mask 3 is designed such that the curvature of the shadow mask 3 is increased when the inner surface curvature of the panel 1 increases, and is decreased when the inner surface curvature of the panel 1 decreases.

Such a design is adapted to enable electron beams emitted from the rear side of the cathode ray tube to accurately strike desired portions of a phosphor surface formed on the inner surface of the panel 1, respectively, and thus, to reproduce a desired image. In designing a shadow mask for a cathode ray tube, therefore, it is desirable to take into consideration the incidence angles of the electron beams and the inherent structural strength characteristics of the shadow mask.

Accordingly, the shadow mask of the present invention, which is shown in FIG. 3, is designed such that the radius of curvature of the shadow mask along an A-A′ direction, that is, a longer-axis direction, and the radius of curvature of the shadow mask along a B-B′ direction, that is, a shorter-axis direction, satisfy a predetermined condition. This will be described in more detail. In accordance with the present invention, the longer-axis curvature radius Rh and shorter-axis curvature radius Rv of the shadow mask are determined such that the longer-axis curvature radius Rh is not less than the shorter-axis curvature radius Rv (Rh≧Rv) at an optional point on the shadow mask.

When the shadow mask satisfies the above-described condition, it has a geometric structure in which the curvature along the longer-axis direction is more convex than the curvature along the shorter-axis direction.

Meanwhile, where the panel 1 has a diagonal-axis inner surface curvature radius of 1,000 to 1,500 mm, the shadow mask 3 has structural strength characteristics exhibiting little variation in accordance with a variation in the geometric structure of the shadow mask 3.

However, when the panel 1 is flatter, that is, has a diagonal-axis inner surface curvature radius of 1,600 mm or more, the shadow mask 3 has structural strength characteristics, such as drop characteristics, exhibiting a great variation in accordance with a variation in the geometric structure of the shadow mask 3.

TABLE 2

| | Longer-Axis | Shorter-Axis | Drop |
|---|---|---|---|
| | Curvature Radius | Curvature Radius | Characteristics |
| Experiment | (mm) | (mm) | (g) |
| 1 | 1,200 | 1,200 | 35.5 |
| 2 | 1,600 | 1,200 | 33.4 |
| 3 | 1,200 | 1,600 | 24.5 |
| 4 | 1,600 | 1,800 | 23.4 |

TABLE 2 describes a variation in drop characteristics depending on a variation in the geometric structure of a shadow mask in a flat cathode ray tube including a panel having a light transmissivity of 40 to 70% and a diagonal-axis inner surface curvature radius of 1,600 mm or more.

The drop characteristics of a shadow mask represent the structural strength characteristics of the shadow mask according to the structure of the shadow mask and frame assembly of the cathode ray tube. Such structural strength characteristics can be experimentally determined by measuring the weight of an object causing a structural deformation of the shadow mask when the object is dropped from a predetermined level to the cathode ray tube.

After comparison of Experiments Nos. 1 and 4 in TABLE 2, it can be seen that the shadow mask exhibits a reduction in drop characteristics in accordance with an increase in the curvature radius of the shadow mask. Such a reduction in drop characteristics means a reduction in the strength of the shadow mask. In this case, accordingly, the shadow mask may be easily deformed, even when impact of a small weight is applied to the shadow mask.

Also, after comparison of Experiments Nos. 2 and 3, it can be seen that the shadow mask exhibits an enhancement in drop characteristics as the longer-axis curvature radius of the shadow mask is larger than the shorter-axis curvature radius of the shadow mask. Accordingly, it can be seen that the structural strength characteristics of the shadow mask are enhanced when the curvature radii of the shadow mask are reduced.

In particular, it is preferred that the shadow mask be designed such that the ratio of the longer-axis curvature radius to the shorter-axis curvature radius, Rh/Rv, satisfies the condition “1<Rh/Rv≦1.2”. Most preferably, the shadow mask is designed such that the ratio of the longer-axis curvature radius to the shorter-axis curvature radius satisfies the condition “1.05<Rh/Rv≦1.15”. Under this condition, optimal results are obtained in achieving desired drop characteristics of the shadow mask and in solving characteristic mismatching of the shadow mask from other elements such as the electron gun adapted to emit electron beams and the deflection yoke adapted to deflect the electron beams.

Meanwhile, the shadow mask must satisfy boundary conditions for not only obtaining desired drop characteristics, but also matching the characteristics of the shadow mask with the characteristics of the electron gun and deflection yoke, and thus, obtaining an accurate beam arrangement. Accordingly, it is preferred that the shorter-axis curvature radius of the shadow mask range from 1,200 mm to 1,600 mm. It is also preferred that the longer-axis curvature radius of the shadow mask range from 1,200 mm to 1,500 mm.

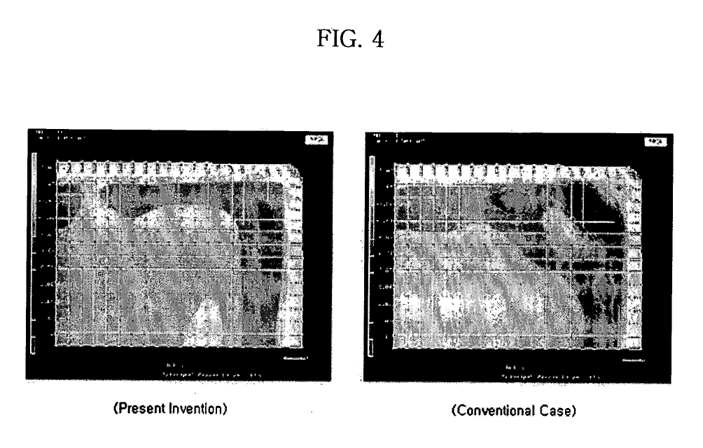

FIG. 4 illustrates comparison of the stress characteristics of the shadow mask in the flat cathode ray tube according to the present invention with the stress characteristics of a conventional shadow mask. Referring to FIG. 4, it can be seen that the conventional shadow mask exhibits stress concentration on the peripheral portion thereof, which may be affected by the longer and shorter-axis curvatures of the shadow mask, but the shadow mask of the present invention exhibits uniform stress distribution, and thus, exhibits an improvement in impact resistance.

As apparent from the above description, the flat cathode ray tube of the present invention uses an improved shadow mask structure capable of preventing a degradation in the structural strength of a shadow mask caused by a panel, which has an inner surface with an approximately-flat curvature to achieve an improvement in contrast characteristics.

Although the preferred embodiments of the invention have been disclosed for illustrative purposes with reference to the annexed drawings illustrating cathode ray tubes, those skilled in the art will appreciate that various modifications, additions and substitutions are possible, without departing from the scope and spirit of the invention as disclosed in the accompanying claims.

1. A shadow mask for a cathode ray tube having a plurality of electron beam holes to perform a color selecting function for electron beams generated in the cathode ray tube, wherein:
the shadow mask has a curvature satisfying, at an optional point on the shadow mask, the following condition:
Rh≧Rv
where, “Rh” represents a shorter-axis radius of the curvature, and “Rv” represents a longer-axis radius of the curvature.

2. The shadow mask according to claim 1, wherein the shadow mask has a ratio of the longer-axis curvature radius to the shorter-axis curvature radius (Rh/Rv) satisfying the following condition:
1<Rh/Rv≦1.2

3. The shadow mask according to claim 2, wherein the ratio of the longer-axis curvature radius to the shorter-axis curvature radius (Rh/Rv) satisfies the following condition:
1.05≦Rh/Rv≦1.15

4. The shadow mask according to claim 1, wherein the shorter-axis curvature radius of the shadow mask ranges from 1,200 mm to 1,600 mm.

5. The shadow mask according to claim 4, wherein the inner surface curvature of the panel has a radius of not less than 1,600 mm.

6. A flat cathode ray tube comprising a panel having a substantially-flat outer surface and an inner surface having a certain curvature, a funnel coupled to a rear end of the panel to form a hollow vacuum body, an electron gun fitted in a neck portion of the funnel to emit electron beams, and a shadow mask arranged at the inner surface of the panel in a state of being spaced apart by a certain distance from the inner surface of the panel, and formed with a plurality of electron beam slots, wherein:
the shadow mask has a curvature satisfying, at an optional point on the shadow mask, the following condition:
Rh≧Rv
where, “Rh” represents a shorter-axis radius of the curvature, and “Rv” represents a longer-axis radius of the curvature.

7. The flat cathode ray tube according to claim 6, wherein the shadow mask has a ratio of the longer-axis curvature radius to the shorter-axis curvature radius (Rh/Rv) satisfying the following condition:
1<Rh/Rv≦1.2

8. The flat cathode ray tube according to claim 7, wherein the ratio of the longer-axis curvature radius to the shorter-axis curvature radius (Rh/Rv) satisfies the following condition:
1.05≦Rh/Rv≦1.15

9. The flat cathode ray tube according to claim 6, wherein the shorter-axis curvature radius of the shadow mask ranges from 1,200 mm to 1,600 mm.

10. The flat cathode ray tube according to claim 9, wherein the inner surface curvature of the panel has a radius of not less than 1,600 mm.

11. The flat cathode ray tube according to claim 6, wherein the longer-axis curvature radius of the shadow mask ranges from 1,200 mm to 1,500 mm.

12. The flat cathode ray tube according to claim 11, wherein the inner surface curvature of the panel has a radius of not less than 1,600 mm.

13. The flat cathode ray tube according to claim 6, wherein the panel has a central portion exhibiting a light transmissivity of 40 to 70%.

14. The flat cathode ray tube according to claim 6, wherein the panel is made of tinted glass.
